(19) United States
(12) Patent Application Publication
(10) Pub. No.: US 2024/0347762 A1
(43) Pub. Date: Oct. 17, 2024

(54) METHOD OF PRODUCING SULFIDE SOLID-STATE ELECTROLYTE

(71) Applicant: TOYOTA JIDOSHA KABUSHIKI KAISHA, Aichi-ken (JP)

(72) Inventors: Keiichi MINAMI, Shizuoka-ken (JP); Hikaru SUGANUMA, Shizuoka-ken (JP)

(21) Appl. No.: 18/627,445

(22) Filed: Apr. 5, 2024

(30) Foreign Application Priority Data
Apr. 7, 2023 (JP) 2023-063049

(51) Int. Cl. H01M 10/0562

(52) U.S. Cl. CPC H01M 10/0562; H01M 2300/0068

(57) ABSTRACT

A method of producing a sulfide solid-state electrolyte having an LGPS-type crystal phase containing Li, Sn, P and S includes: amorphizing a raw material composition, to obtain an ion-conductive material; heating the ion-conductive material in an inert gas stream, to obtain a sulfide solid-state electrolyte intermediate; pulverizing the sulfide solid-state electrolyte intermediate into a fine particle form, to obtain intermediate fine particles; and heating the intermediate fine particles at a temperature of from 300° C. to 450° C. in an inert gas stream, to obtain a sulfide solid-state electrolyte.

### CROSS-REFERENCE TO RELATED APPLICATION

This application is based on and claims priority under 35 USC 119 from Japanese Patent Application No. 2023-063049, filed on Apr. 7, 2023, the disclosure of which is incorporated by reference herein.

### TECHNICAL FIELD

The present disclosure relates to a method of producing a sulfide solid-state electrolyte.

### RELATED ART

All solid-state batteries are batteries that include a solid-state electrolyte layer between a positive electrode layer and a negative electrode layer. All solid-state batteries have an advantage in that simplification of safety devices is simple as compared to liquid-state batteries including electrolytic solutions containing flammable organic solvents. Sulfide solid-state electrolytes are known as solid-state electrolytes for use in all solid-state batteries.

Japanese Patent No. 5527673, for example, discloses a sulfide solid-state electrolyte that contains element M1 (for example, Li), element M2 (for example, Ge and P), and S element, and that has a peak at a predetermined position in X-ray diffractometry. Further, International Publication (WO) No. 2013/118722 discloses a sulfide solid-state electrolyte that contains element M1 (for example, Li), element M2 (for example, Sn and P), and S element, and that has a peak at a predetermined position in X-ray diffractometry.

From the viewpoint of reducing resistance in batteries, sulfide solid-state electrolytes for use in batteries are desired to exhibit high dispersibility in electrodes, and, in some cases, sulfide solid-state electrolytes are used in the form of fine particles for this reason. However, there are cases in which generation of fine particles by pulverization of sulfide solid-state electrolytes results in decrease in crystallinity, which in turn leads to lowered water resistance. As a result, hydrogen sulfide (H₂S) is generated in some cases when exposed to the atmosphere containing moisture.

In consideration of the foregoing circumstances, the present disclosure addresses provision of a method of producing a sulfide solid-state electrolyte that is in the form of fine particles, and that exhibits reduced generation of hydrogen sulfide (H₂S) when the sulfide solid-state electrolyte is exposed to the atmosphere containing moisture.

<1> A method of producing a sulfide solid-state electrolyte having an LGPS-type crystal phase containing Li, Sn, P and S, the method including:
an amorphization step of amorphizing a raw material composition, to obtain an ion-conductive material;
a first heating step of heating the ion-conductive material in an inert gas stream, to obtain a sulfide solid-state electrolyte intermediate;
a powderization step of pulverizing the sulfide solid-state electrolyte intermediate into a fine particle form, to obtain intermediate fine particles; and
a second heating step of heating the intermediate fine particles at a temperature of from 300° C. to 450° C. in an inert gas stream, to obtain a sulfide solid-state electrolyte.

<2> The method of producing a sulfide solid-state electrolyte according to <1>, wherein the raw material composition has a composition represented by Li₄₋ₓSn₁₋ₓPₓS₄, and 0.55≤x≤0.76.

<3> The method of producing a sulfide solid-state electrolyte according to <1> or <2>, wherein the sulfide solid-state electrolyte has an average particle diameter of 1.0 μm or less.

<4> The method of producing a sulfide solid-state electrolyte according to any one of <1> to <3>, wherein the sulfide solid-state electrolyte has a full width at half maximum (FWHM) of a peak at a 2θ of 26.70±0.50° of 0.73 or less in an X-ray diffractometry.

According to the present disclosure, a method of producing a sulfide solid-state electrolyte that is in the form of fine particles, and that exhibits reduced generation of hydrogen sulfide (H₂S) when the sulfide solid-state electrolyte is exposed to the atmosphere containing moisture, is provided.

### BRIEF DESCRIPTION OF THE DRAWINGS

FIG. 1 is a flow chart showing an example of a method of producing a sulfide solid-state electrolyte according to an embodiment of the present disclosure.

FIG. 2 is a perspective view explaining an example of the crystal structure of a sulfide solid-state electrolyte material of the present disclosure.

FIG. 3 is a schematic cross-sectional view showing an example of a battery to which a sulfide solid-state electrolyte obtained by the production method according to an embodiment of the present disclosure can be applied.

FIG. 4 is a graph showing results of an X-ray diffractometry of sulfide solid-state electrolytes of Examples and Comparative Examples.

### MODES FOR CARRYING OUT THE INVENTION

The method of producing a sulfide solid-state electrolyte according to the present disclosure is described below in detail.

### <Method of Producing Sulfide Solid-State Electrolyte>

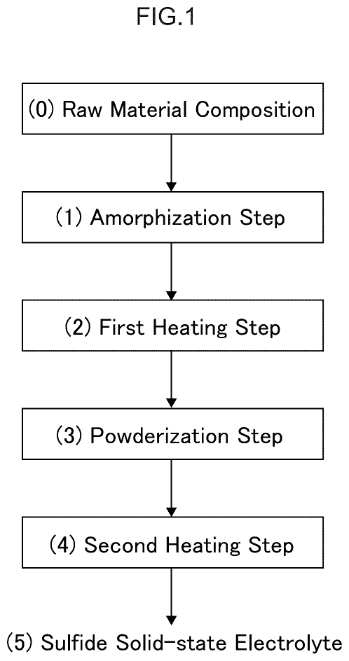

FIG. 1 is a flow chart showing an example of a method of producing a sulfide solid-state electrolyte according to an embodiment of the present disclosure. As shown in FIG. 1, the method of producing a sulfide solid-state electrolyte produces a sulfide solid-state electrolyte having an LGPS-type crystal phase containing Li, Sn, P and S through the following steps:
(1) an amorphization step of amorphizing a raw material composition, to obtain an ion-conductive material;
(2) a first heating step of heating the ion-conductive material in an inert gas stream, to obtain a sulfide solid-state electrolyte intermediate (hereinafter also referred to simply as “intermediate”);
(3) a powderization step of pulverizing the sulfide solid-state electrolyte intermediate into a fine particle form, to obtain intermediate fine particles; and
(4) a second heating step of heating the intermediate fine particles at a temperature of from 300° C. to 450° C. in an inert gas stream, to obtain a sulfide solid-state electrolyte.

According to the method of producing a sulfide solid-state electrolyte according to an embodiment of the present disclosure, a sulfide solid-state electrolyte that is in the form of fine particles, and that exhibits reduced generation of hydrogen sulfide (H₂S) when the sulfide solid-state electrolyte is exposed to the atmosphere containing moisture can be obtained via the above-described steps. We surmise that the reason that the effect can be exerted is as follows.

Sulfide solid-state electrolytes for use in batteries are required to exhibit high dispersibility in electrodes, from the viewpoint of reducing resistance in the batteries. From this standpoint, sulfide solid-state electrolytes are made to have a fine particle form in order to obtain high dispersibility. However, there are cases in which pulverization of a sulfide solid-state electrolyte obtained in a sulfide solid-state electrolyte production process decreases crystallinity of the sulfide solid-state electrolyte. The sulfide solid-state electrolyte having a decreased crystallinity has a reduced water resistance, and generates hydrogen sulfide (H₂S) due to reaction with moisture when the sulfide solid-state electrolyte is exposed to the atmosphere containing moisture.

In contrast, the method of producing a sulfide solid-state electrolyte according to an embodiment of the present disclosure includes a second heating step of heating (baking) the intermediate fine particles at a temperature in a temperature range of from 300° C. to 450° C., after the powderization step of pulverizing the sulfide solid-state electrolyte intermediate into a fine particle form. It is conceivable that this further heating at the above-specified temperature makes it possible to improve the crystallinity of the sulfide solid-state electrolyte after powderization, and to improve water resistance, and that, as a result, generation of hydrogen sulfide (H₂S) can be reduced even when the sulfide solid-state electrolyte is exposed to the atmosphere containing moisture.

### (0) Raw Material Composition

In the method of producing a sulfide solid-state electrolyte, a raw material composition is prepared first. The raw material composition includes Li, Sn, P and S. The raw material composition is preferably a mixture containing a Li source, a Sn source, a P source and a S source. The Li source is, for example, a Li-containing sulfide. The Li-containing sulfide is, for example, Li₂S. Examples of the Sn source include Sn simple substance and a Sn-containing sulfide. The Sn-containing sulfide is, for example, SnS₂. Examples of the P source include P simple substance and a P-containing sulfide. The P-containing sulfide is, for example, P₂S₅. Examples of the S source include S simple substance, a Li-containing sulfide, an Sn-containing sulfide, and a P-containing sulfide.

The raw material composition can be prepared, for example, by mixing Li₂S, SnS₂ and P₂S₅. Here, it is preferable that the raw material composition is prepared in an inert gas (for example, Ar gas or He gas) atmosphere in order to prevent deterioration of the raw material composition caused by moisture in the air.

The raw material composition preferably has a composition represented by Li₄₋ₓSn₁₋ₓPₓS₄, and 0.55≤x≤0.76. From the viewpoint of forming a single composition, x is preferably in a range of from 0.55 to 0.76. The lower limit of x is more preferably greater than or equal to 0.57, still more preferably greater than or equal to 0.59, further preferably greater than or equal to 0.61, and still further preferably greater than or equal to 0.63. The upper limit of x is more preferably less than or equal to 0.74, and still more preferably less than or equal to 0.72.

### (1) Amorphization Step

The amorphization step is a step of amorphizing the raw material composition, to obtain an ion-conductive material.

The method used for amorphizing the raw material composition is not particularly limited, and examples thereof include a mechanical milling method and a melt quenching method. The mechanical milling method includes pulverizing the raw material composition while applying a mechanical energy. Examples of the mechanical milling include a ball mill, a vibration mill, a turbo mill, and a disc mill. The conditions for the amorphization may be appropriately set so as to obtain a desired ion-conductive material.

In the case of using a planetary ball mill, the rotation number of the sun wheel is, for example, preferably from 200 rpm (revolutions per minute) to 600 rpm, and more preferably from 250 rpm to 350 rpm. The duration of processing by the planetary ball mill is, for example, preferably from 1 hour to 100 hours, and more preferably from 5 hours to 70 hours.

In the case of using a vibration mill, the amplitude of vibration is, for example, preferably from 5 mm to 15 mm, and more preferably from 6 mm to 10 mm. The vibration frequency of the vibration mill is, for example, preferably from 500 rpm to 2000 rpm, and more preferably from 1000 rpm to 1800 rpm. The vibration mill to be used is preferably an oscillator (for example, an oscillator made of aluminum). The duration of processing by the vibration mill is, for example, preferably from 1 hour to 100 hours, and more preferably from 5 hours to 70 hours.

It will be noted that the amorphization step is preferably performed in an inert gas (for example, Ar gas or He gas) atmosphere in order to prevent deterioration of the ion-conductive material caused by moisture in the air.

### (2) First Heating Step

The first heating step is a step of heating the ion-conductive material in an inert gas stream, to obtain a sulfide solid-state electrolyte intermediate (intermediate). The heating of the amorphized ion-conductive material can improve the crystallinity.

Examples of the inert gas include noble gases such as argon (Ar) and hellium (He). The inert gas may also include other gases, in a range in which the desired intermediate can be obtained. The flow rate of the inert gas is not particularly limited, and the flow rate is set, as appropriate, such that the desired intermediate can be obtained.

The heating conditions in the first heating step are also set, as appropriate, such that the desired intermediate can be obtained. The heating temperature is, for example, preferably higher than or equal to 300° C., more preferably higher than or equal to 400° C., and still more preferably higher than or equal to 500° C. The upper limit of the heating temperature is, for example, preferably lower than or equal to 1000° C., more preferably lower than or equal to 700° C., and still more preferably lower than or equal to 600° C.

The heating time is set, as appropriate, such that the desired intermediate can be obtained. The heating time is, for example, preferably from 1 hour to 20 hours, more preferably from 2 hours to 10 hours, and still more preferably from 3 hours to 8 hours.

It is preferable that the temperature elevation up to the foregoing heating temperature is performed gradually. The time it takes for the temperature elevation is, for example, preferably from 5 hours to 20 hours, and more preferably from 7 hours to 15 hours.

The heating apparatus to be used for the heating is, for example, a gas flow or a baking furnace.

### (3) Powderization Step

The powderization step is a step of powdering the sulfide solid-state electrolyte intermediate (intermediate), to obtain intermediate fine particles.

The method used for powdering the intermediate is not particularly limited, and, for example, the same method as that used in the amorphization step may be used, examples of which include a mechanical milling method and a melt quenching method. Examples of the mechanical milling include a ball mill, a vibration mill, a turbo mill, and a disc mill. The conditions for the powderization are set, as appropriate, such that the desired ion-conductive material can be obtained.

In the case of using a planetary ball mill in the powderization step, the rotation number of the sun wheel is, for example, preferably from 50 rpm to 600 rpm, and more preferably from 100 rpm to 400 rpm. The duration of processing by the planetary ball mill is, for example, preferably from 0.1 hour to 10 hours, more preferably from 0.5 hours to 5 hours, and still more preferably from 1 hour to 2 hours.

It will be noted that the powderization step is preferably performed in an inert gas (for example, Ar gas or He gas) atmosphere in order to prevent deterioration of the intermediate caused by moisture in the air.

### (4) Second Heating Step

The second heating step is a step of heating the intermediate fine particles at a temperature of from 300° C. to 450° C. in an inert gas stream, to obtain a sulfide solid-state electrolyte. This additional heating applied to the intermediate fine particles can improve the crystallinity.

The inert gas to be used can be the same gas as that used in the first heating step, and examples thereof include noble gases such as argon (Ar) and helium (He). The inert gas may further include other gases in a range in which the desired sulfide solid-state electrolyte can be obtained. Further, the flow rate of the inert gas is not particularly limited, and the flow rate is set, as appropriate, such that the desired sulfide solid-state electrolyte can be obtained.

The heating temperature in the second heating step is set to be from 300° C. to 450° C. In a case in which the heating temperature is lower than 300° C., the crystallinity of the sulfide solid-state electrolyte cannot be heightened, and the generation of hydrogen sulfide (H₂S) cannot be suppressed when the resultant sulfide solid-state electrolyte is exposed to the air containing moisture. In a case in which the heating temperature is higher than 450° C., the generation of hydrogen sulfide (H₂S) cannot be suppressed when the resultant sulfide solid-state electrolyte is exposed to the air containing moisture. The heating temperature is more preferably from 320° C. to 430° C., and still more preferably from 350° C. to 400° C.

The heating time is set, as appropriate, such that the desired sulfide solid-state electrolyte can be obtained. The heating time is, for example, preferably from 1 hour to 20 hours, more preferably from 2 hours to 10 hours, and still more preferably from 3 hours to 8 hours.

Here, it is preferable that the temperature elevation up to the foregoing heating temperature is performed gradually. The time it takes for the temperature elevation is, for example, preferably from 5 hours to 20 hours, and more preferably from 7 hours to 15 hours.

Any of the apparatuses listed in the section for the first heating step is also usable as the heating apparatus to be used for the heating in the second heating step.

### Sulfide Solid-State Electrolyte

The sulfide solid-state electrolyte obtained by the foregoing production method has an LGPS-type crystal phase containing Li, Sn, P and S. This sulfide solid-state electrolyte is processed into the form of fine particles, and exhibits reduced generation of hydrogen sulfide (H₂S) when the sulfide solid-state electrolyte is exposed to the air containing moisture.

### Peak Attributable to LGPS-Type Crystal Phase

It is preferable that the sulfide solid-state electrolyte having an LGPS-type crystal phase obtained by the foregoing production method (i) has a peak at 2θ=29.31°±0.50° in an X-ray diffractometry using CuKα radiation, and (ii) does not have a peak at 2θ=27.33°±0.50° in an X-ray diffractometry using CuKα radiation, or, has a peak at 2θ=27.33°±0.50° and the value of I_{B}/I_{A} is lower than 1.00 wherein I_{A} represents the diffraction intensity of the peak at 2θ=29.31°±0.50° and I_{B} represents the diffraction intensity of the peak at 2θ=27.33°±0.50°. The peak at or around 2θ=29.31° is one of the peaks of a crystal phase having high ion conductivity, and the peak at or around 2θ=27.33° is one of the peaks of a crystal phase having low ion conductivity. From the viewpoint of ion conductivity, the value of I_{B}/I_{A} is preferably small, and more preferably less than or equal to 0.50, less than or equal to 0.45, less than or equal to 0.25, less than or equal to 0.15, or less than or equal to 0.07. It is further preferable that I_{B}/I_{A} is 0, that is, the peak at or around 20-27.33° is not present.

With respect to the actual measurement value of the peak at 2θ=29.31° of the sulfide solid-state electrolyte material, the position of the peak may slightly deviate from 2θ=29.31° to some degree due to changes in the crystal lattice depending on material composition and the like. In consideration of this, the peak is specified as a peak at a position of 29.31°±0.50°. The crystal phase is considered to usually have peaks at 2θ=20.00°, 20.31°, 26.70°, and 29.31°. These peak positions may also vary in a range of ±0.50°.

The X-ray diffractometry for the sulfide solid-state electrolyte is carried out on a powder sample in an inert gas atmosphere, using CuKα radiation.

### Structure of LGPS-Type Crystal Phase

It is preferable that the sulfide solid-state electrolyte having an LGPS-type crystal phase obtained by the above-described production method mainly includes a crystal structure having octahedral O composed of Li element and S element, tetrahedral T₁ composed of Sn or P element and S element, and tetrahedral T₂ composed of P element and S element, in which the tetrahedral T₁ and the octahedral O share an edge, and the tetrahedral T₂ and the octahedral O share a corner. Since the octahedral O, the tetrahedral T₁ and the tetrahedral T₂ have a specified crystal structure (three-dimensional structure), a sulfide solid-state electrolyte material having an excellent ion conductivity can be obtained. It is conceivable that the high ion conductivity is exhibited by metal ions (for example, Li ions) travelling through space portions in this crystal structure.

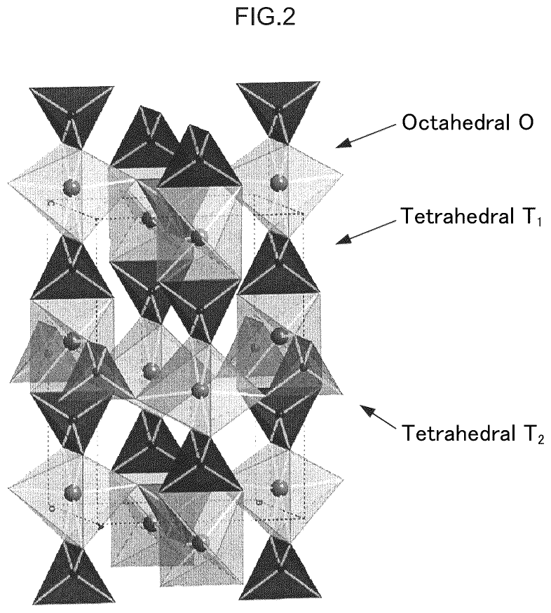

FIG. 2 is a perspective view explaining an example of the crystal structure of the sulfide solid-state electrolyte material having an LGPS-type crystal phase. In the crystal structure shown in FIG. 2, the octahedral O has Li as the central element and has six S atoms at octahedral corners, typically LiS₆ octahedron. The tetrahedral T₁ has Sn or P as the central element and has four S atoms at the tetrahedron corners, typically both a SnS₄ tetrahedron and a PS₄ tetrahedron. The tetrahedral T₂ has P as the central element and has four S atoms at the tetrahedron corners, typically a PS₄ tetrahedron. Further, the tetrahedral T₁ and the octahedral O share an edge, and the tetrahedral T₂ and the octahedral O share a corner. The crystal structure of the sulfide solid-state electrolyte material is determined by X-ray structural analysis. The crystal system and the crystal group are determined by the direct method based on a diffraction pattern obtained by XRD, and the crystal structure is then determined by the real space method.

### Particle Diameter

The sulfide solid-state electrolyte obtained preferably has an average particle diameter of less than or equal to 1.0 μm, more preferably less than or equal to 0.9 μm, and still more preferably less than or equal to 0.8 μm. The lower limit of the average particle diameter is preferably greater than or equal to 0.1 μm, more preferably greater than or equal to 0.3 μm, and still more preferably greater than or equal to 0.5 μm.

The average particle diameter of the sulfide solid-state electrolyte is an average primary particle diameter as measured by the LASER diffraction method. Specific procedures for the measurement are as follows.

The average particle diameter is measured by the LASER diffraction method, using a MASTERSIZER 200 manufactured by MALVERN, and calculated from the volume average particle diameter. Specifically, MASTERSIZER 2000 manufactured by Malvern Instruments Ltd. is used as the measurement instrument, 110 ml of toluene (manufactured by Fujifilm Wako Pure Chemical Corporation; product name: Special Grade), which has been subjected to dehydration treatment, is added into a dispersion vessel of the instrument, and tertiary butyl alcohol (manufactured by Fujifilm Wako Pure Chemical Corporation; Special Grade) as a dispersant, which has been subjected to dehydration treatment, is added in an amount of 6% by mass. The above mixture is sufficiently mixed, and, thereafter, the sulfide solid-state electrolyte is added, and the particle diameter thereof is measured.

### FWHM

As the index of the crystallinity of the sulfide solid-state electrolyte, the full width at half maximum (FWHM) of the peak at 2θ=26.70±0.50° in a X-ray diffractometry (XRD) is preferably 0.73 or less, more preferably 0.70 or less, still more preferably 0.65 or less, and further preferably 0.60 or less.

For obtaining the FWHM, the sulfide solid-state electrolyte obtained is subjected to structural analysis using an X-ray diffractometry (XRD), and the FWHM of the main peak (2θ=) 26.70±0.50° is calculated by Gaussian fitting.

### Composition

The sulfide solid-state electrolyte obtained preferably has a composition represented by Li₄₋ₓSn₁₋ₓPₓS₄, and 0.55≤x≤0.76. From the viewpoint of forming a single composition, x is preferably in a range of from 0.55 to 0.76. The lower limit of x is more preferably greater than or equal to 0.57, still more preferably greater than or equal to 0.59, further preferably greater than or equal to 0.61, and further more preferably greater than or equal to 0.63. The upper limit of x is more preferably less than or equal to 0.74, and still more preferably less than or equal to 0.72.

### Ion Conductivity

The sulfide solid-state electrolyte obtained preferably has a high Li ion conductivity. The ion conductivity (at 25° C.) of the sulfide solid-state electrolyte is, for example, preferably greater than or equal to 1.00 mS/cm, more preferably greater than or equal to 1.30 mS/cm, and still more preferably greater than or equal to 1.50 mS/cm, from the viewpoint of improving the performance in terms of charging and discharging when the sulfide solid-state electrolyte is used in a battery.

### Applications

The sulfide solid-state electrolyte obtained can be used in any use in which ion conductivity is required. In particular, the sulfide solid-state electrolyte is suitably used in a battery.

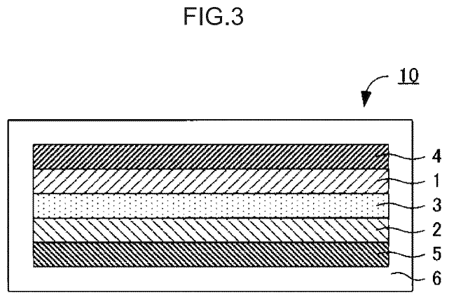

FIG. 3 is a schematic cross-sectional view showing an example of a battery to which the sulfide solid-state electrolyte obtained by the production method according to an embodiment of the present disclosure (hereinafter also referred to as simply the “sulfide solid-state electrolyte of the present disclosure) can be applied. A battery 10 shown in FIG. 3 includes a positive electrode layer 1 containing a positive electrode active material, a negative electrode layer 2 containing a negative electrode active material, an electrolyte layer 3 disposed between the positive electrode layer 1 and the negative electrode layer 2, a positive electrode current collector 4 configured to collect an electric current for the positive electrode 1, a negative electrode current collector 5 configured to collect an electric current for the negative electrode 2, and an outer casing 6 that houses these members. In the present disclosure, the sulfide solid-state electrolyte of the present disclosure can be applied to at least one of the positive electrode layer 1, the negative electrode layer 2, or the electrolyte layer 3.

### EXAMPLES

The present disclosure is described further specifically below, with reference to examples.

### Example 1

Lithium sulfide (Li₂S, manufactured by Nippon Chemical Industrial CO., LTD.), phosphorus pentoxide (P₂S₅, manufactured by Aldrich), and tin sulfide (SnS₂, manufactured by Kojundo Chemical Laboratory Co., Ltd.) were used as starting raw materials. These powders were weighed out in a glove box under an argon atmosphere such that x in Li₄₋ₓSn₁₋ₓPₓS₄ would be x=0.70, and the powders were mixed in an agate mortar. A raw material composition was obtained thereby.

Thereafter, the obtained raw material composition and grinding balls (zirconia balls) were added into a container (zirconia pot) in a glove box under an argon atmosphere, and the container was sealed. Here, the volume of the grinding balls added was adjusted to about ⅙ of the volume of the container, and the mass of the raw material composition added was adjusted to about 1/50 of the mass of the grinding balls. This container was attached to a planetary ball mill machine (P7 manufactured by Fritsch), and mechanical milling was performed at a sun wheel rotation number of 300 rpm for 20 hours (amorphization step). An ion conductive material was obtained thereby.

Then, the ion conductive material obtained was placed on a graphite boat, and heated in an Ar gas stream. The heating conditions involved temperature elevation from room temperature to 570° C. over a temperature elevation time of 10 hours, holding at 570° C. for 6 hours, and subsequent gradual cooling to room temperature (first heating step). As a result of this heating step, a sulfide solid-state electrolyte intermediate was obtained.

Thereafter, the sulfide solid-state electrolyte intermediate and grinding balls (zirconia balls) were added into a container (zirconia pot) in a glove box under an argon atmosphere, and the container was sealed. Here, the volume of the grinding balls added was adjusted to about ⅙ of the volume of the container, and the mass of the raw material composition added was adjusted to about 1/50 of the mass of the grinding balls. The container was attached to a planetary ball mill machine (P7 manufactured by Fritsch), and mechanical milling was performed at a sun wheel rotation number of 250 rpm for 1.5 hours (powderization step). Intermediate fine particles were obtained thereby.

Then, the intermediate fine particles obtained were placed on a graphite boat, and heated in an Ar gas stream. The heating conditions involved temperature elevation from room temperature to 300° C. over a temperature elevation time of 2 hours, holding at 300° C. for 6 hours, and subsequent gradual cooling to room temperature (second heating step). As a result of this heating step, a sulfide solid-state electrolyte having a composition represented by Li₄₋ₓSn₁₋ₓPₓS₄, in which x is 0.70, was obtained.

### Example 2

A sulfide solid-state electrolyte was obtained in the same manner as that in Example 1, except that the heating temperature in the second heating step was changed to the temperature indicated in Table 1.

### Comparative Example 1

A sulfide solid-state electrolyte was obtained in the same manner as that in Example 1, except that the second heating step was not carried and, instead, the particles directly after the powderization step was taken as the sulfide solid-state electrolyte.

### Comparative Examples 2 and 3

Sulfide solid-state electrolytes were obtained in the same manner as that in Example 1, except that the heating temperature in the second heating step was changed to the temperatures indicated in Table 1.

### —Evaluation—

### (Measurement of H₂S Generation Amount)

The amount of H₂S generated was measured in an environment having a dew point of −30° C., using the sulfide solid-state electrolytes obtained in the Examples and Comparative Examples as samples. First, a 1 L glass desiccator was placed in a dry air glove box having a dew point of −30° C., 10 mg of the sample was weighed out and placed in an aluminum container, and the aluminum container containing the sample was placed in the glass desiccator. The lid of the glass desiccator was closed in a state in which the fan was rotating, and the sample was exposed to the environment having a dew point of −30° C. for 5 hours. The H₂S generated in this period was measured by a sensor (manufacturer: ToxiRAEPro, Model: 0-100 ppm, Measurement Mode: None), and H₂S generation amount (ppm) per unit specific surface area was calculated. The results are shown in Table 1.

### (X-Ray Diffractometry)

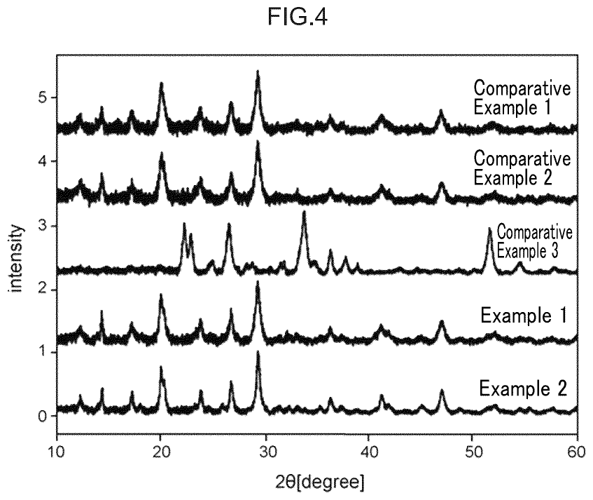

The sulfide solid-state electrolytes obtained in the Examples and Comparative Examples were subjected to an X-ray diffractometry (XRD). The XRD measurement was carried out for the powder sample in an inert atmosphere, using CuKα radiation. The results are shown in FIG. 4.

The FWHM of the main peak (2θ=26.70±0.50°) was calculated by Gaussian fitting. The results are shown in Table 1.

### (Ion Conductivity Measurement)

Each of the sulfide solid-state electrolytes obtained in the Examples and Comparative Examples was weighed out in an amount of 200 mg, placed in a cylinder manufactured by Macor, and pressed at a pressure of 4 ton/cm². Both ends of the pellet obtained was pinched by SUS pins, and a confining pressure was applied to the pellet by bolting. The sample obtained was held at 25° C., and, at this state, the ion conductivity thereof was calculated by the alternating current impedance method. For the measurement, SOLARTRON 1260 was used with an applied voltage of 5 mV and a measurement frequency range of from 0.01 MHz to 1 MHz. The results are shown in Table 1.

### (Average Particle Diameter)

The average particle diameter (average primary particle diameter) of each of the sulfide solid-state electrolytes of the Examples and Comparative Examples was measured according to the foregoing method. The results are shown in Table 1.

TABLE 1

| | Second | Evaluation | | | |
|---|---|---|---|---|---|
| | Heating Step | H₂S Generation | | Ion | |
| | Heating | Amount | XRD FWHM | Conductivity | Average Particle |
| | Temperature | [ppm] | [°] | [mS/cm] | Diameter [μm] |
| Comparative | No Baking | 45 | 0.85 | 0.92 | 0.4 |
| Example 1 | | | | | |
| Comparative | 150° C. | 45 | 0.78 | 1.21 | 0.4 |
| Example 2 | | | | | |
| Comparative | 550° C. | 80 | — | 0.01 | 1.2 |
| Example 3 | | | | | |
| Example 1 | 300° C. | 40 | 0.72 | 1.33 | 0.7 |
| Example 2 | 450° C. | 10 | 0.51 | 2.06 | 0.9 |

As shown in Table 1, in Examples 1 and 2, in which heating at a temperature of from 300° C. to 450° C. is carried out in the second heating step, exhibited a small FWHM of 0.73 or less and a high ion conductivity of 1.30 or higher, as compared to Comparative Example 1, in which the second heating step was not carried out, Comparative Example 2, in which the heating temperature in the second heating step was lower than 300° C., and Comparative Example 3, in which the heating temperature in the second heating step was higher than 450° C. In addition, the Examples exhibited reduced generation of hydrogen sulfide (H₂S), as compared to the Comparative Examples.

What is claimed is:

1. A method of producing a sulfide solid-state electrolyte having an LGPS-type crystal phase containing Li, Sn, P and S, the method comprising:
amorphizing a raw material composition, to obtain an ion-conductive material;
heating the ion-conductive material in an inert gas stream, to obtain a sulfide solid-state electrolyte intermediate;
pulverizing the sulfide solid-state electrolyte intermediate into a fine particle form, to obtain intermediate fine particles; and
heating the intermediate fine particles at a temperature of from 300° C. to 450° C. in an inert gas stream, to obtain a sulfide solid-state electrolyte.

2. The method of producing a sulfide solid-state electrolyte according to claim 1, wherein the raw material composition has a composition represented by Li₄₋ₓSn₁₋ₓPₓS₄, and 0.55≤x≤0.76.

3. The method of producing a sulfide solid-state electrolyte according to claim 1, wherein the sulfide solid-state electrolyte has an average particle diameter of 1.0 μm or less.

4. The method of producing a sulfide solid-state electrolyte according to claim 1, wherein the sulfide solid-state electrolyte has a full width at half maximum (FWHM) of a peak at a 2θ of 26.70±0.50° of 0.73 or less in an X-ray diffractometry.
